(19) United States
(12) Patent Application Publication
(10) Pub. No.: US 2009/0159830 A1
(43) Pub. Date: Jun. 25, 2009

(54) Fluid transportation device

(75) Inventors: Shih Chang Chen, Hsin-Chu (TW); Ying Lun Chang, Hsin-Chu (TW); Rong Ho Yu, Hsin-Chu (TW); Shih Che Chiu, Hsin-Chu (TW)

Correspondence Address: BACON & THOMAS, PLLC, 625 SLATERS LANE, FOURTH FLOOR, ALEXANDRIA, VA, 22314-1176, US

(73) Assignee: Microjet Technology Co., Ltd., Hsin-Chu (TW)

(21) Appl. No.: 12/314,729

(22) Filed: Dec. 16, 2008

(30) Foreign Application Priority Data
Dec. 21, 2007 (CN) 200710160177.8

(51) Int. Cl. F16K 1/32

(52) U.S. Cl. 251/356

(57) ABSTRACT

A fluid transportation device includes a valve seat, a valve cap, a valve membrane, multiple buffer chambers, and an actuating module. The valve seat has an inlet channel and an outlet channel. The valve cap is disposed on the valve seat. The valve membrane is arranged between the valve seat and the valve cap. The multiple buffer chambers include a first buffer chamber between the valve membrane and the valve cap and a second buffer chamber between the valve membrane and the valve seat. Each of the first buffer chamber and the second buffer chamber has a flow-guiding structure extended from an outer edge to a center thereof. The actuating module has a periphery fixed on the valve cap. A pressure cavity is defined between the actuating module and the valve cap. Another flow-guiding structure is formed at an inner edge of the pressure cavity.

### FIELD OF THE INVENTION

The present invention relates to a fluid transportation device, and more particularly to a fluid transportation device for use in a micro pump.

### BACKGROUND OF THE INVENTION

Nowadays, fluid transportation devices used in many sectors such as pharmaceutical industries, computer techniques, printing industries, energy industries are developed toward miniaturization. The fluid transportation devices used in for example micro pumps, micro atomizers, printheads or industrial printers are very important components. Consequently, it is critical to improve the fluid transportation devices.

FIG. 1A is a schematic cross-sectional view illustrating a micro pump in a non-actuation status. The micro pump 10 principally comprises an inlet channel 13, a micro actuator 15, a transmission device 14, a diaphragm 12, a compression chamber 111, a substrate 11 and an outlet channel 16. The compression chamber 111 is defined between the diaphragm 12 and the substrate 11 and accommodates a fluid therein. Depending on the deformation amount of the diaphragm 12, the capacity of the compression chamber 111 is varied.

When a voltage is applied on both electrodes of the micro actuator 15, an electric field is generated. The electric field causes downward deformation of the micro actuator 15 such that the micro actuator 15 is moved toward the diaphragm 12 and the compression chamber 111. Since the micro actuator 15 is disposed on the transmission device 14, a pushing force generated by the micro actuator 15 is exerted on the transmission device 14. Through the transmission device 14, the pushing force is transmitted to the diaphragm 12 and thus the diaphragm 12 is distorted. Since the diaphragm 12 is compressed and deformed as shown in FIG. 1B, the fluid within the compression chamber 111 will flow to a predetermined vessel (not shown) through the outlet channel 16 in the direction indicated as the arrow X. With continuous flow of the fluid, the fluid in the inlet channel 13 is supplied to the compression chamber 111.

FIG. 2 is a schematic top view of the micro pump shown in FIG. 1A. As shown in FIG. 2, the fluid is transported by the micro pump in the direction indicated as the arrow Y. The micro pump 10 has an inlet flow amplifier 17 and an outlet flow amplifier 18. The inlet flow amplifier 17 and the outlet flow amplifier 18 are cone-shaped. The relatively larger end of the inlet flow amplifier 17 is connected to the inlet channel 191 and the relatively smaller end of the inlet flow amplifier 17 is connected to the compression chamber 111. The relatively larger end of the outlet flow amplifier 18 is connected to the compression chamber 111 and the relatively smaller end of the outlet flow amplifier 18 is connected to the outlet channel 192. In addition, the inlet flow amplifier 17 and the outlet flow amplifier 18 are arranged in the same direction. Due to the different flow resistances at both ends of the flow amplifiers and the volume expansion/compression of the compression chamber 111, a unidirectional net flow rate is rendered. That is, the fluid flows from the inlet channel 191 into the compression chamber 111 through the inlet flow amplifier 17 and then flows out of the outlet channel 192 through the outlet flow amplifier 18.

This valveless micro pump 10, however, still has some drawbacks. For example, some fluid may return back to the input channel when the micro pump is in the actuation status. For enhancing the net flow rate, the compression ratio of the compression chamber 111 should be increased to result in a sufficient chamber pressure. Under this circumstance, a costly micro actuator 15 is required.

Therefore, there is a need of providing a fluid transportation device for use in a micro pump to obviate the drawbacks encountered from the prior art.

### SUMMARY OF THE INVENTION

It is an object of the present invention to provide a fluid transportation device having improved flow channels. These flow channels are applicable to the fluid transportation device of a micro pump for enhancing the performance and preventing air bubble accumulation.

In accordance with an aspect of the present invention, there is provided a fluid transportation device for transporting a fluid. The fluid transportation device includes a valve seat, a valve cap, a valve membrane, multiple buffer chambers, and an actuating module. The valve seat has an inlet channel and an outlet channel. The valve cap is disposed on the valve seat. The valve membrane is arranged between the valve seat and the valve cap. The multiple buffer chambers include a first buffer chamber between the valve membrane and the valve cap and a second buffer chamber between the valve membrane and the valve seat. Each of the first buffer chamber and the second buffer chamber has a flow-guiding structure extended from an outer edge to a center thereof. The actuating module has a periphery fixed on the valve cap. A pressure cavity is defined between the actuating module and the valve cap. Another flow-guiding structure is formed at an inner edge of the pressure cavity.

The above contents of the present invention will become more readily apparent to those ordinarily skilled in the art after reviewing the following detailed description and accompanying drawings, in which:

### BRIEF DESCRIPTION OF THE DRAWINGS

FIG. 1A is a schematic cross-sectional view illustrating a micro pump in a non-actuation status;

FIG. 1B is a schematic cross-sectional view illustrating a micro pump in an actuation status;

FIG. 2 is a schematic top view of the micro pump shown in FIG. 1A;

FIG. 3 is a schematic exploded view of a fluid transportation device according to the present invention;

FIG. 4 is a schematic cross-sectional view illustrating the valve seat of the fluid transportation device shown in FIG. 3;

FIG. 5A is a schematic backside view illustrating the valve cap of the fluid transportation device shown in FIG. 3;

FIG. 5B is a schematic cross-sectional view of the valve cap shown in FIG. 5A;

FIGS. 6A, 6B and 6C schematically illustrate the valve membrane of the fluid transportation device shown in FIG. 3;

FIG. 7A is a schematic cross-sectional view illustrating the fluid transportation device in a non-actuation status according to the present invention;

FIG. 7B is a schematic cross-sectional view illustrating the fluid transportation device of the present invention, in which the volume of the pressure cavity is expanded;

FIG. 7C is a schematic cross-sectional view illustrating the fluid transportation device of the present invention, in which the volume of the pressure cavity is shrunken;

FIG. 8 is a flowchart illustrating a process of fabricating a fluid transportation device of the present invention;

FIG. 9A is a schematic front view of a modified valve cap according to a first preferred embodiment of the present invention;

FIG. 9B is a schematic backside view illustrating the valve cap shown in FIG. 9A;

FIG. 10 is a schematic rear view of a modified valve seat according to a second preferred embodiment of the present invention;

FIG. 11A is a schematic cross-sectional view of a fluid transportation device according to a third preferred embodiment of the present invention is illustrated;

FIG. 11B is a partially schematic enlarged view of the portion C of the fluid transportation device shown in FIG. 11A;

FIG. 12A is a schematic cross-sectional view of a fluid transportation device according to a fourth preferred embodiment of the present invention is illustrated;

FIG. 12B is a partially schematic enlarged view of the portion D of the fluid transportation device shown in FIG. 12A;

FIG. 13A is a schematic cross-sectional view of a fluid transportation device according to a fifth preferred embodiment of the present invention is illustrated; and

FIG. 13B is a partially schematic enlarged view of the portion E of the fluid transportation device shown in FIG. 13A.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

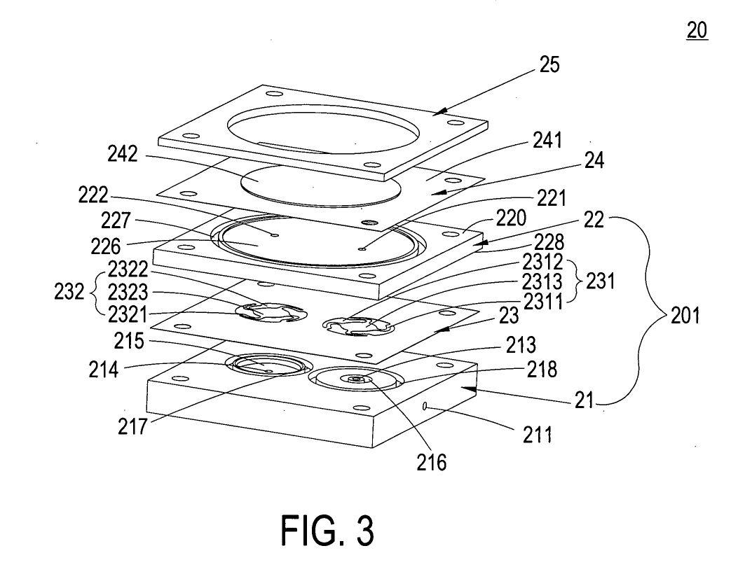

Referring to FIG. 3, a schematic exploded view of a fluid transportation device according to a preferred embodiment of the present invention is illustrated. The fluid transportation device 20 may be used in many sectors such as pharmaceutical industries, computer techniques, printing industries, energy industries for transporting fluids such as gases or liquids. The fluid transportation device 20 principally comprises a valve seat 21, a valve cap 22, a valve membrane 23, several buffer chambers, an actuating module 24 and a cover plate 25. The valve seat 21, the valve cap 22 and the valve membrane 23 collectively define a flow valve seat assembly 201. A pressure cavity 226 is formed between the valve cap 22 and the actuating module 24 for storing a fluid therein.

After the valve membrane 23 is sandwiched between the valve seat 21 and the valve cap 22, the valve seat 21 and the valve cap 22 are disposed on opposite sides of the valve membrane 23. Consequently, a first buffer chamber is defined between the valve membrane 23 and the valve cap 22 and a second buffer chamber is defined between the valve membrane 23 and the valve seat 21. The actuating module 24 is disposed above the valve cap 22, and comprises a vibration film 241 and an actuator 242. The actuating module 24 is operated to actuate the fluid transportation device 20. The cover plate 25 is disposed over the actuating module 24. Meanwhile, the valve seat 21, the valve membrane 23, the valve cap 22, the actuating module 24 and the cover plate 25 are sequentially stacked from bottom to top, thereby assembling the fluid transportation device 20.

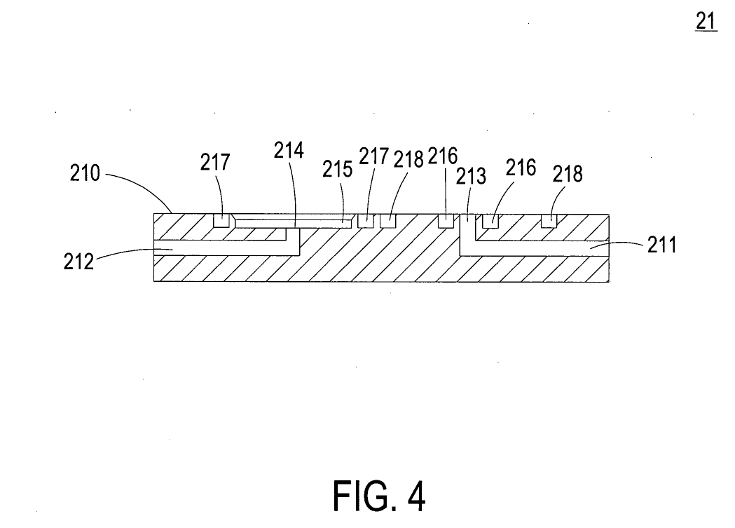

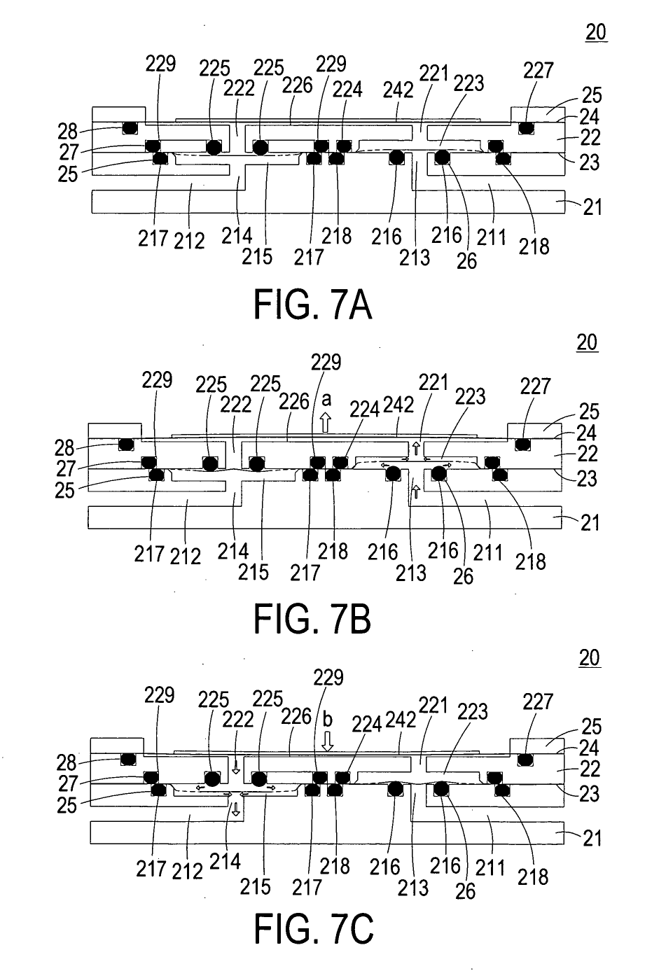

In particular, the valve seat 21 and the valve cap 22 are responsible for guiding the fluid into or out of the fluid transportation device 20. FIG. 4 is a schematic cross-sectional view illustrating the valve seat 21 of the fluid transportation device 20 shown in FIG. 3. Please refer to FIGS. 3 and 4. The valve seat 21 comprises an inlet channel 211 and an outlet channel 212. The ambient fluid is introduced into the inlet channel 211 and then transported to an opening 213 in a surface 210 of the valve seat 21. The second buffer chamber defined between the valve membrane 23 and the valve seat 21 is the outlet buffer cavity 215, which is formed in the surface 210 of the valve seat 21 and over the outlet channel 212. The outlet buffer cavity 215 is communicated with the outlet channel 212 for temporarily storing the fluid therein. The fluid contained in the outlet buffer cavity 215 is transported to the outlet channel 212 through another opening 214 and then exhausted out of the valve seat 21. Moreover, several recess structures are formed in the valve seat 21 and several sealing rings 26 (as shown in FIG. 7A) are embedded into corresponding recess structures. The valve seat 21 has two recess structures 216 and 218 annularly surrounding the opening 213 and another recess structure 217 surrounding the outlet buffer cavity 215.

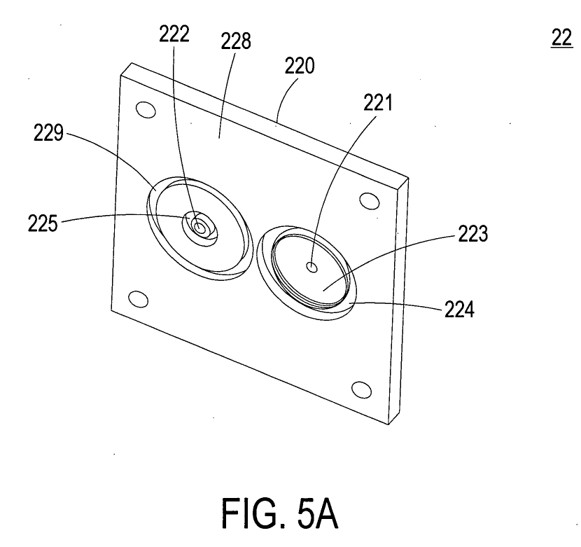

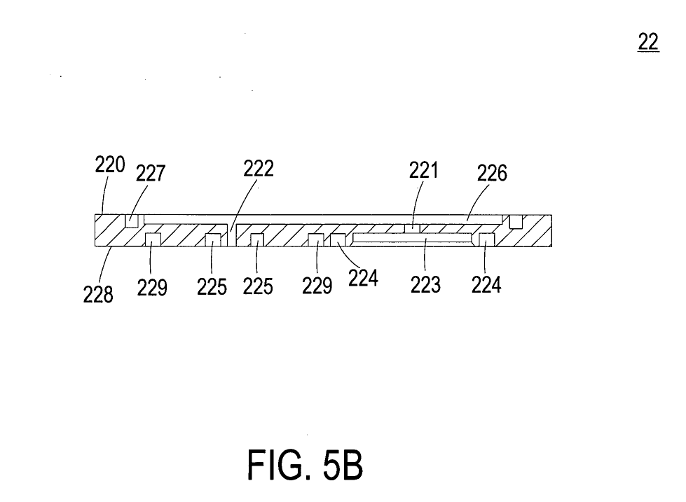

FIG. 5A is a schematic backside view illustrating the valve cap 22 of the fluid transportation device 20 shown in FIG. 3. Please refer to FIGS. 3 and 5A. The valve cap 22 has an upper surface 220 and a lower surface 228. The valve cap 22 further comprises an inlet valve channel 221 and an outlet valve channel 222, which are perforated from the upper surface 220 to the lower surface 228 of the valve cap 22. The inlet valve channel 221 is aligned with the opening 213 of the valve seat 21. The outlet valve channel 222 is aligned with the opening 214 within the outlet buffer cavity 215 of the valve seat 21. The first buffer chamber defined between the valve membrane 23 and the valve cap 22 is the inlet buffer cavity 223, which is formed in the lower surface 228 of the valve cap 22 and under the inlet valve channel 221. The inlet buffer cavity 223 is communicated with the inlet valve channel 221.

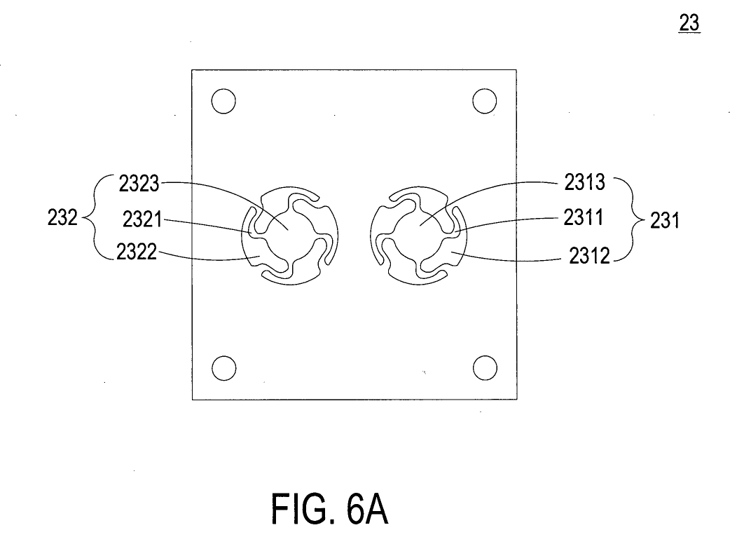

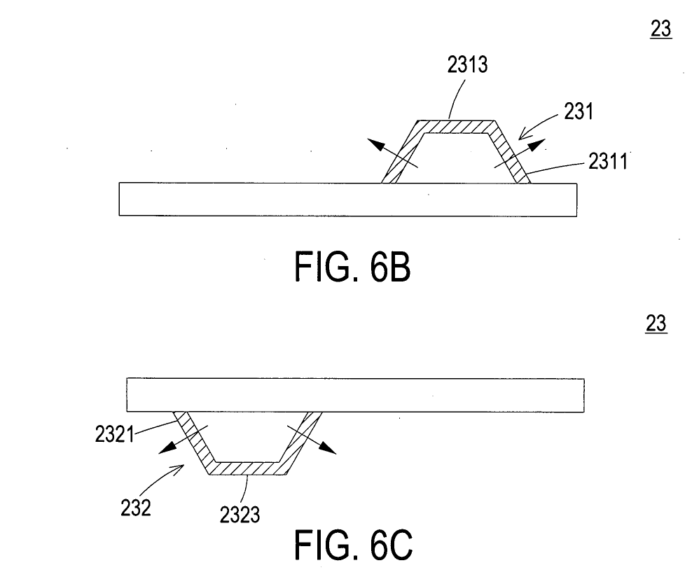

FIG. 5B is a schematic cross-sectional view of the valve cap 22 shown in FIG. 5A. As shown in FIG. 5B, the pressure cavity 226 is formed in the upper surface 220 of the valve cap 22 corresponding to the actuator 242 of the actuating module 24. The pressure cavity 226 is communicated with the inlet buffer cavity 223 through the inlet valve channel 221. The pressure cavity 226 is also communicated with the outlet valve channel 222. In a case that the actuator 242 is subject to upwardly convex deformation due to a voltage applied thereon, the volume of the pressure cavity 226 is expanded to result in a negative pressure difference from the ambient air. In response to the negative pressure difference, the fluid is transported into the pressure cavity 226 through the inlet valve channel 221. In a case that the direction of the electric field applied on the actuator 242 is changed such that the actuator 242 is subject to downwardly concave deformation, the volume of the pressure cavity 226 is shrunk to result in a positive pressure difference from the ambient air. In response to the positive pressure difference, the fluid is exhausted out of the pressure cavity 226 through the outlet valve channel 222 while a portion of fluid is introduced into the inlet valve channel 221 and the inlet buffer cavity 223. Since the inlet valve structure 231 is pressed down to its closed position at this moment (as shown in FIG. 6C), no fluid is allowed to flow through the inlet valve structure 231 and thus the fluid will not be returned back. Furthermore, if the actuator 242 is subject to upwardly convex deformation to expand the volume of the pressure cavity 226 again, the fluid temporarily stored in the inlet buffer cavity 223 will be transported into the pressure cavity 226 through the inlet valve channel 221.

Similarly, the valve cap 22 further has several recess structures. The valve cap 22 has a recess structure 227 formed in the upper surface 220 and surrounding the pressure cavity 226. The valve cap 22 has another recess structure 224 formed in the lower surface 228 and surrounding the inlet buffer cavity 223. In addition, valve cap 22 has recess structures 225 and 229 formed in the lower surface 228 and annularly surrounding the outlet valve channel 222. Similarly, several sealing rings 27 (as shown in FIG. 7A) are embedded into corresponding recess structures 224, 225, 227 and 229.

FIG. 6A is a schematic top view of the valve membrane 23 of the fluid transportation device 20 shown in FIG. 3. Please refer to FIGS. 3 and 6A. The valve membrane 23 is produced by a conventional machining process, a photolithography and etching process, a laser machining process, an electroforming process, an electric discharge machining process and so on. The valve membrane 23 is a sheet-like membrane with substantially uniform thickness and comprises several hollow-types valve switches (e.g. first and second valve switches). The first valve switch is an inlet valve structure 231 and the second valve switch is an outlet valve structure 232. The inlet valve structure 231 comprises an inlet valve slice 2313 and several perforations 2312 formed in the periphery of the inlet valve slice 2313. In addition, the inlet valve structure 231 has several extension parts 2311 between the inlet valve slice 2313 and the perforations 2312. In a case that a stress transmitted from the pressure cavity 226 is exerted on the valve membrane 23, the whole inlet valve structure 231 is pressed down to lie flat on the valve seat 21 (as shown in FIG. 7C). In other words, the inlet valve slice 2313 is in close contact with the sealing ring 26 received in the recess structure 216 so as to seal the opening 213 of the valve seat 21 while the perforations 2312 and the extension parts 2311 are floated over the valve seat 21. Under this circumstance, the inlet valve structure 231 is in a closed position and thus no fluid can flow therethrough.

If the volume of the pressure cavity 226 is expanded to result in suction, the sealing ring 26 received in the recess structure 216 will provide a pre-force on the inlet valve structure 231. Since the extension parts 2311 may facilitate supporting the inlet valve slice 2313 to result in a stronger sealing effect, the fluid will not be returned back through the inlet valve structure 231. If a negative pressure difference in the pressure cavity 226 causes upward shift of the inlet valve structure 231 (as shown in FIG. 6B), the fluid is flowed from the valve seat 21 into the inlet buffer cavity 223 through the perforations 2312 and then transmitted to the pressure cavity 226 through the inlet buffer cavity 223 and the inlet valve channel 221. Under this circumstance, the inlet valve structure 231 is selectively opened or closed in response to the positive or negative pressure difference in the pressure cavity 226, so that the fluid is controlled to flow through the fluid transportation device without being returned back to the valve seat 21.

Similarly, the outlet valve structure 232 comprises an outlet valve slice 2323 and several perforations 2322 formed in the periphery of the outlet valve slice 2323. In addition, the outlet valve structure 232 has several extension parts 2321 between the outlet valve slice 2323 and the perforations 2322. The operation principles of the outlet valve slice 2323, the extension parts 2321 and the perforations 2322 included in the outlet valve structure 232 are similar to corresponding components of the inlet valve structure 231, and are not redundantly described herein. On the other hand, the sealing rings 26 in the vicinity of the outlet valve structure 232 are opposed to the sealing rings 27 in the vicinity of the inlet valve structure 231. If the volume of the pressure cavity 226 is shrunken to result in an impulse (as shown in FIG. 6C), the sealing ring 27 received in the recess structure 225 will provide a pre-force on the outlet valve structure 232. Since the extension parts 2321 may facilitate supporting the outlet valve slice 2323 to result in a stronger sealing effect, the fluid will not be returned back through the outlet valve structure 232. If a positive pressure difference in the pressure cavity 226 causes downward shift of the outlet valve structure 232, the fluid is flowed from the pressure cavity 226 into the output buffer cavity 215 through the perforations 2322 of the valve seat 21 and then exhausted out of the fluid transportation device 20 through the opening 214 and the outlet channel 212. Under this circumstance, the outlet valve structure 232 is opened to drain out the fluid contained in the pressure cavity 226 so as to transport the fluid.

FIG. 7A is a schematic cross-sectional view illustrating the fluid transportation device in a non-actuation status according to the present invention. Three sealing rings 26 are respectively received in the recess structures 216, 217 and 218, and three sealing rings 27 are respectively received in the recess structures 224, 225 and 229. The sealing rings 26 and 27 are made of excellent chemical-resistant rubbery material. The sealing ring 26 received in the recess structure 216 and surrounding the opening 213 is a cylindrical ring. The thickness of the sealing ring 26 is greater than the depth of the recess structure 216 such that the sealing ring 26 is partially protruded from the upper surface 210 of the valve seat 21. Since the sealing ring 26 is partially protruded from the upper surface 210 of the valve seat 21, the inlet valve slice 2313 of the valve membrane 23 that lies flat on the valve seat 21 is raised but the remainder of the valve membrane 23 is sustained against the valve cap 22 such that the sealing ring 26 received in the recess structure 216 will provide a pre-force on the inlet valve structure 231. The pre-force results in a stronger sealing effect, and thus the fluid will not be returned back through the inlet valve structure 231. In addition, since the raised structure of the sealing ring 26 is in the vicinity of the inlet valve structure 231 of the valve membrane 23, a gap is formed between the inlet valve slice 2313 and the upper surface 210 of the valve seat 21 if the inlet valve structure 231 is not actuated. Similarly, the sealing ring 27 received in the recess structure 225 and surrounding the outlet valve channel 222 is also a cylindrical ring. Since the sealing ring 27 is formed in the lower surface 228 of the valve cap 22, the sealing ring 27 is partially protruded from the recess structure 225 to form a raised structure. Consequently, the sealing ring 27 received in the recess structure 225 will provide a pre-force on the outlet valve structure 232. The raised structure of the sealing ring 27 and the raised structure of the sealing ring 26 are arranged on opposite sides of the valve membrane 23. The functions of the raised structure of the sealing ring 27 are similar to that of the raised structure of the sealing ring 26, and are not redundantly described herein. The sealing rings 26, 27 and 28 received in the recess structures 217, 218, 224, 229 and 227 may facilitate close contact between the valve seat 21 and the valve membrane 23, between the valve membrane 23 and the valve cap 22, and between the valve cap 22 and the actuating module 24 to avoid fluid leakage.

In the above embodiments, the raised structures are defined by the recess structures and corresponding sealing rings. Alternatively, the raised structures may be directly formed on the valve seat 21 and the valve cap 22 by a photolithography and etching process, an electroplating process or an electroforming process.

Please refer to FIGS. 7A, 7B and 7C. The cover plate 25, the actuating module 24, the valve cap 22, the valve membrane 23, the sealing rings 26 and the valve seat 21 are assembled as described above. As shown in the drawings, the opening 213 of the valve seat 21 is aligned with the inlet valve structure 231 of the valve membrane 23 and the inlet valve channel 221 of the valve cap 22. In addition, the opening 214 of the valve seat 21 is aligned with the outlet valve structure 232 of the valve membrane 23 and the outlet valve channel 222 of the valve cap 22. Since the sealing ring 26 received in the recess structure 216 is partially protruded from the recess structure 216, the inlet valve structure 231 of the valve membrane 23 is slightly raised from the valve seat 21. Under this circumstance, the sealing ring 26 received in the recess structure 216 will provide a pre-force on the inlet valve structure 231. If the inlet valve structure 231 is not actuated, a gap is formed between the inlet valve structure 231 and the upper surface 210 of the valve seat 21. Similarly, the sealing ring 27 received in the recess structure 225 results in gap between the outlet valve structure 232 and the lower surface 228 of the valve cap 22.

When a voltage is applied on the actuator 242, the actuating module 24 is subject to deformation. As shown in FIG. 7B, the actuating module 24 is upwardly deformed in the direction “a” and thus the volume of the pressure cavity 226 is expanded to result in suction. Due to the suction, the inlet valve structure 231 and the outlet valve structure 232 of the valve membrane 23 are uplifted. Meanwhile, the inlet valve slice 2313 of the inlet valve structure 231 possessing the pre-force is quickly opened (as also shown in FIG. 6B) so that a great amount of fluid is introduced into the inlet channel 211 of the valve seat 21, transported through the opening 213 of the valve seat 21, the perforations 2312 of the inlet valve structure 231 of the valve membrane 23, the inlet buffer chamber 223 of the valve cap 22, the inlet valve channel 221 of the valve cap 22, and flowed into the pressure cavity 226. Since the inlet valve structure 231 and the outlet valve structure 232 of the valve membrane 23 are uplifted at this moment, the outlet valve channel 222 of the valve cap 22 is blocked by the outlet valve slice 2323 of outlet valve structure 232. Consequently, the outlet valve structure 232 is closed to prevent the fluid from being returned back.

In a case that the actuating module 24 is downwardly deformed in the direction “b” by switching the electric field (as shown in FIG. 7C), the volume of the pressure cavity 226 is shrunken to exert an impulse on the fluid in the pressure cavity 226. Due to the impulse, the inlet valve structure 231 and the outlet valve structure 232 of the valve membrane 23 are moved downwardly such that the outlet valve slice 2323 of outlet valve structure 232 is quickly opened (as shown in FIG. 6C). Meanwhile, the fluid in the pressure cavity 226 is flowed through the outlet valve channel 222 of the valve cap 22, the perforations 2322 of the outlet valve structure 232 of the valve membrane 23, the outlet buffer chamber 215 of the valve seat 21, the opening 214 and the outlet channel 212, and then exhausted out of the fluid transportation device 20. Since the impulse is also exerted on the inlet valve structure 231, the opening 213 is blocked by the inlet valve slice 2313. Consequently, the inlet valve structure 231 is closed to prevent the fluid from being returned back. In other words, the inlet valve structure 231, the outlet valve structure 232 and the sealing rings 26 and 27 received in the recess structures 216 and 225 may collectively facilitate preventing the fluid from being returned back during transportation, thereby achieving efficient fluid transportation.

The valve seat 21 and the valve cap 22 used in the fluid transportation device 20 of the present invention is preferably made of thermoplastic material such as polycarbonate (PC), polysulfone (PSF), acrylonitrile butadiene styrene (ABS) resin, linear low density polyethylene (LLDPE), low density polyethylene (LDPE), high density polyethylene (HDPE), polypropylene (PP), polyphenylene sulfide (PPS), syndiotactic polystyrene (SPS), polyphenylene oxide (PPO), polyacetal (POM), polybutylene terephthalate (PBT), polyvinylidene fluoride (PVDF), ethylene-tetrafluoroethylene (ETFE), cyclic olefin copolymer (COC) and so no. Preferably, the pressure cavity 226 has a depth of 100 μm to 300 μm and a diameter of 10 mm to 30 mm.

The valve membrane 23 is separated from the valve seat 21 and the valve cap 22 by a gap of 10 μm to 790 μm (preferably 180 μm to 300 μm). The vibrating film 241 of the actuating module 24 is separated from the valve cap 22 by a gap of 10 μm to 790 μm (preferably 100 μm to 300 μm).

The valve membrane 23 may be produced by a conventional machining process, a photolithography and etching process, a laser machining process, an electroforming process, an electric discharge machining process and so on. The valve membrane 23 is made of excellent chemical-resistant organic polymeric material having a Young's modulus of 2 to 20 GPa or metallic material having a Young's modulus (or elastic modulus) of 2 to 240 GPa. An example of the organic polymeric material includes polyimide (PI) (Young's modulus=10 GPa). An example of the metallic material includes but is not limited to aluminum (Young's modulus=70 GPa), aluminum alloy, nickel (Young's modulus=210 GPa), nickel alloy, copper, copper alloy or stainless steal (Young's modulus=240 GPa). The thickness of the valve membrane 23 is ranged from 10 μm to 50 μm, preferably from 21 μm to 40 μm.

In a case that the valve membrane 23 is made of polyimide (PI), the valve membrane 23 is preferably produced by a reactive ion etching (RIE) process. After a photosensitive photoresist is applied on the valve structure and the pattern of the valve structure is exposed and developed, the polyimide layer uncovered by the photoresist is etched so as to define the valve structure of the valve membrane 23. In a case that the valve membrane 23 is made of stainless steel, the valve membrane 23 is preferably produced by a photolithography and etching process, a laser machining process or a machining process. By using the photolithography and etching process, a photoresist pattern of the valve structure is formed on a stainless steel piece, and then dipped in a solution of FeCl₃ and HCl to perform a wet etching procedure. The stainless steel piece uncovered by the photoresist is etched so as to define the valve structure of the valve membrane 23. In a case that the valve membrane 23 is made of nickel, the valve membrane 23 is preferably produced by an electroforming process. After a photoresist pattern of the valve structure is formed on a stainless steel piece by a photolithography and etching process, the stainless steel piece uncovered by the photoresist is electroformed by nickel. Until the nickel thickness is desired, the nickel is detached from the stainless steel piece so as to form the valve membrane 23 having the valve structures 231 and 232. In addition to the above processes, the valve membrane 23 may be produced by a precise punching process, a conventional machining process, a laser machining process, an electroforming process or an electric discharge machining process.

In some embodiments, the actuator 242 of the actuating module 24 is a piezoelectric strip made of highly piezoelectric material such as lead zirconate titanate (PZT). The actuator 24 has a thickness of 100 μm to 500 μm (preferably 150 μm to 250 μm) and a Young's modulus of about 100 to 150 GPa.

The vibration film 241 is a single-layered metallic structure having a thickness of 10 μm to 300 μm (preferable 100 μm to 250 μm). For example, the vibration film 241 is made of stainless steel (having a thickness of 140 μm to 160 μm and a Young's modulus of 240 GPa) or copper (having a thickness of 190 μm to 210 μm and a Young's modulus of 100 GPa). Alternatively, the vibration film 241 is a two-layered structure, which includes a metallic layer and a biochemical-resistant polymeric sheet attached on the metallic layer.

In some embodiments, for complying with the requirement of large flow rate transportation, the actuator 242 of the actuating module 24 is operated at a frequency of 10˜50 Hz and under the following conditions.

For example, the actuator 24 has a rigid property and a thickness of about 100 μm to 500 μm. Preferably, the actuator 24 has a thickness of about 150 μm to 250 μm and a Young's modulus of about 100 to 150 GPa. In addition, the vibration film 241 is a single-layered metallic structure having a thickness of 10 μm to 300 μm (preferable 100 μm to 250 μm) and a Young's modulus of 60 to 300 GPa. For example, the vibration film 241 is made of stainless steel (having a thickness of 140 μm to 160 μm and a Young's modulus of 240 GPa) or copper (having a thickness of 190 μm to 210 μm and a Young's modulus of 100 GPa). Alternatively, the vibration film 241 is a two-layered structure, which includes a metallic layer and a biochemical-resistant polymeric sheet attached on the metallic layer. Each of the inlet valve structure 231 and the outlet valve structure 232 is made of excellent chemical-resistant organic polymeric or metallic material having a thickness of 10 μm to 50 μm and a Young's modulus of 2 to 240 GPa. The valve membrane 23 is made of polymeric material having a Young's modulus of 2 to 20 GPa, such as polyimide (PI) (Young's modulus=10 GPa); metallic material having a Young's modulus of 2 to 240 GPa, such as aluminum (Young's modulus=70 GPa), aluminum alloy, nickel (Young's modulus=210 GPa), nickel alloy, copper, copper alloy or stainless steal (Young's modulus=240 GPa). In addition, the valve membrane 23 is separated from the valve seat 21 and the valve cap 22 by a gap of 10 μm to 790 μm (preferably 180 μm to 300 μm).

By selecting proper parameters of the actuator 242, the vibrating film 241, the pressure cavity 226 and the valve membrane 23, the inlet valve structure 231 and the outlet valve structure 232 of the valve membrane 23 are selectively opened or closed. Consequently, a unidirectional net flow rate of the fluid is rendered and the fluid in the pressure cavity 226 is transported at a flow rate of 5 cc/min.

When the fluid transportation device 20 of the present invention is actuated by the actuating module 24, the inlet valve structure 231 of the valve membrane 23 and the sealing ring 26 in the recess structure 216 are cooperated to open the inlet valve structure 231 such that the fluid is transported to the pressure cavity 226. Next, by switching the electric field of the actuating module 24, the volume of the pressure cavity 226 is changed. The outlet valve structure 232 of the valve membrane 23 and the sealing ring 27 in the recess structure 225 are cooperated to open the outlet valve structure 232 such that the fluid is transported out of the pressure cavity 226. Since the suction or the impulse generated when the volume of the pressure cavity 226 is expanded or shrunken is very large, the valve structures are quickly opened to transport a great amount of fluid and prevent the fluid from being returned back.

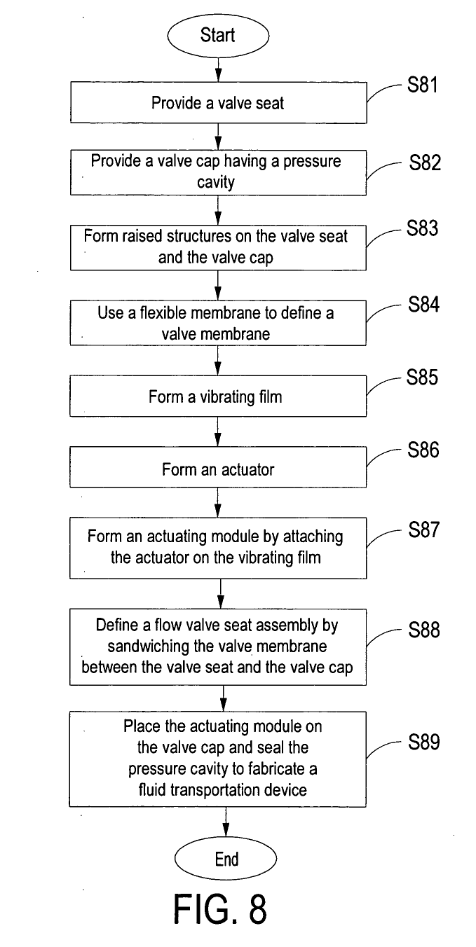

Hereinafter, a process of fabricating a fluid transportation device of the present invention will be illustrated with reference to the flowchart of FIG. 8 and the exploded view of FIG. 3.

First of all, a valve seat 21 is provided (Step S81). Next, a valve cap 22 having a pressure cavity 226 is provided (Step S82). Next, raised structures are formed on the valve seat 21 and the valve cap 22 (Step S83). The raised structures may be formed as described in FIG. 3. That is, at least one recess structure is formed in each of the valve seat 21 and the valve cap 22. For example, a sealing ring 26 is received in the recess structure 216 of the valve seat 21 (as shown in FIG. 7A). Since the sealing ring 26 received in the recess structure 216 is partially protruded from the upper surface 210 of the valve seat 21, a raised structure is formed on the upper surface 210 of the valve seat 21. Likewise, since the sealing ring 27 received in the recess structure 225 is partially protruded from the lower surface 228 of the valve cap 22, another raised structure is formed on the lower surface 228 of the valve cap 22 (as shown in FIG. 5B). Alternatively, the raised structures may be directly formed on the valve seat 21 and the valve cap 22 by a photolithography and etching process, an electroplating process or an electroforming process.

Next, a flexible membrane is used to define the valve membrane 23 having the valve structures 231 and 232 (Step S84). Next, a vibrating film 241 is formed (Step S85) and an actuator 242 is formed (Step S86). The actuator 242 is attached on the vibrating film 241 to form an actuating module 24 (Step S87), in which the actuator 242 faces the pressure cavity 226. Next, the valve membrane 23 is sandwiched between the valve seat 21 and the valve cap 22 to define a flow valve seat assembly 201 (Step S88) such that the valve seat 21 and the valve cap 22 are disposed on opposite sides of the valve membrane 23. Afterwards, the actuating module 24 is placed on the valve cap 22 and the pressure cavity 226 of the valve cap 22 is sealed by the actuating module 24, thereby fabricating the fluid transportation device of the present invention (Step S89).

Please refer to FIG. 7A again. Although the fluid transportation device of the present invention is effective to prevent the fluid from being returned back, there are still some drawbacks required to be further overcome. For example, since the inner corners of the inlet buffer cavity 223, the output buffer cavity 215 and the pressure cavity 226 are all right angles and the junctions between these cavities and the inlet channel 211 and the outlet channel 212 are all right angles, these right angles may become dead spaces of fluid transportation. In addition, since air bubbles are readily remained at the dead spaces, the pumping performance is deteriorated.

As previously described, if a tiny shift of the actuator is caused, the flow is readily resident in the outer periphery of the pressure cavity of the valve cap and air bubbles are possibly accumulated at such a location. For solving this problem, the valve cap should be modified.

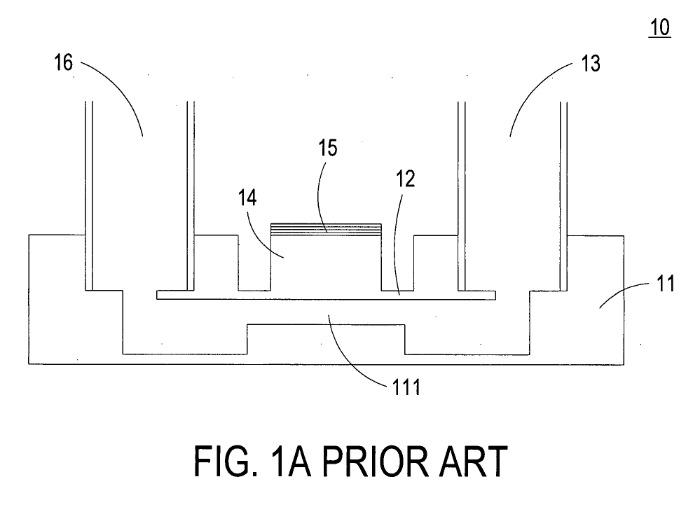

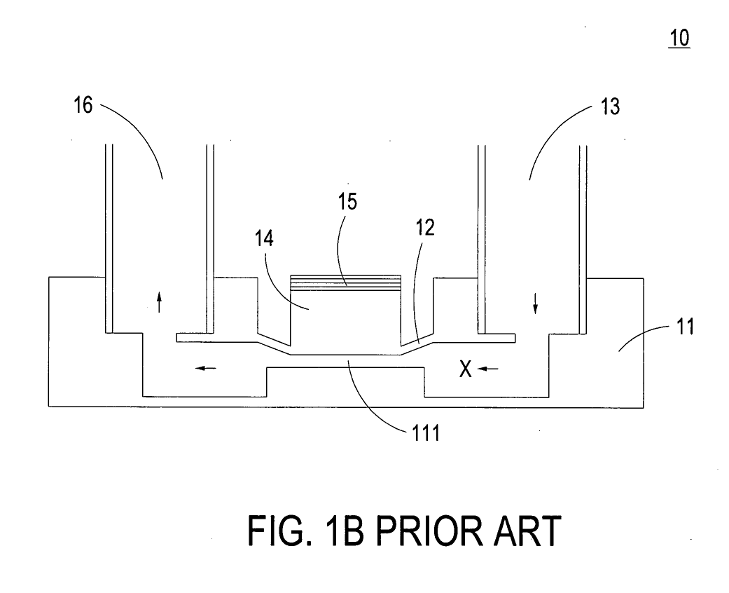

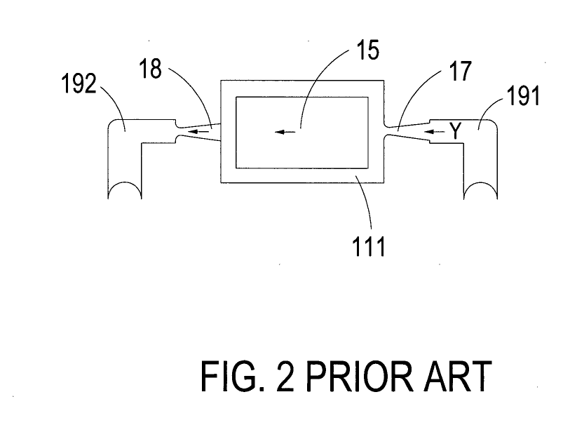

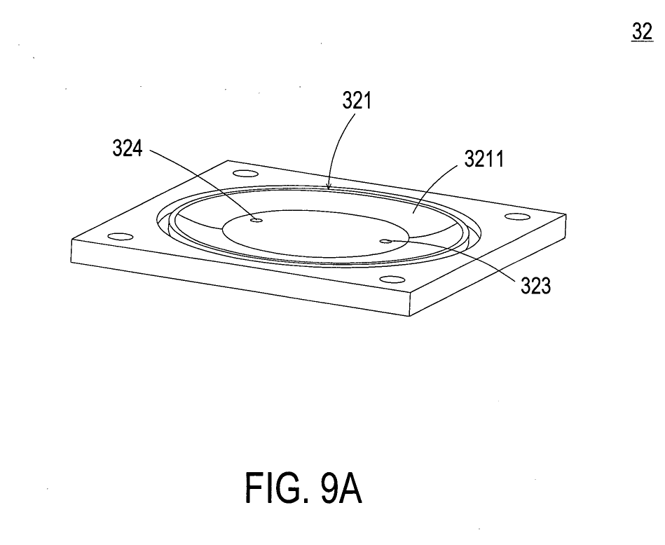

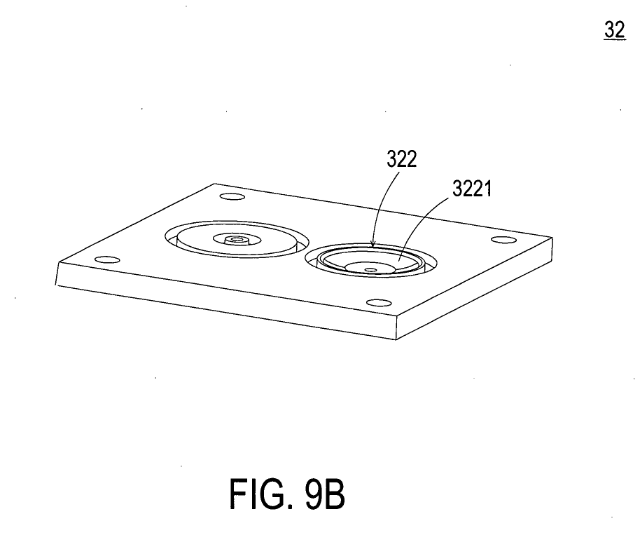

FIG. 9A is a schematic front view of a modified valve cap according to a first preferred embodiment of the present invention. For filling the resident region in the pressure cavity 321 of the valve cap 32, a flow-guiding structure 3211 is formed at the inner edge of the pressure cavity 321 of the valve cap 32. The flow-guiding structure 3211 is a slant surface or a curved surface. The flow-guiding structure 3211 as shown in FIG. 1B is a slant surface. The flow-guiding structure 3211 is not restricted to the slant surface as long as the flow-guiding structure 3211 is effective for preventing accumulation of air bubbles when a flow passes through the pressure cavity 321.

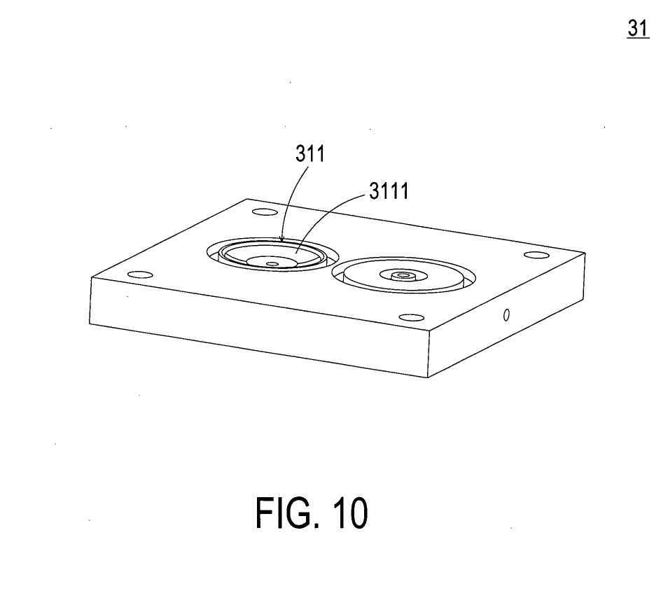

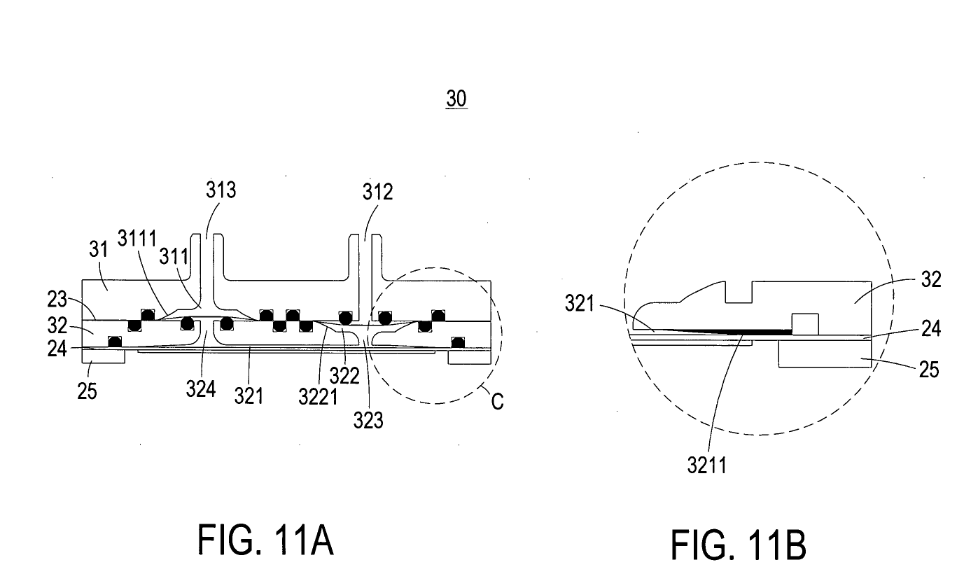

For preventing generation of dead spaces and air bubbles, the right angles of the inlet buffer cavity 322 and the outlet buffer cavity 311 need to be improved. Please refer to FIGS. 9B and 10. FIG. 9B is a schematic backside view illustrating the valve cap shown in FIG. 9A. FIG. 10 is a schematic rear view of a modified valve seat according to a second preferred embodiment of the present invention. For filling the resident regions in the backside of the inlet buffer cavity 322 of the valve cap 32 and the outlet buffer cavity 311 of the valve seat 31, a flow-guiding structure 3221 is extended from the outer edge to the center of the inlet buffer cavity 322 and another flow-guiding structure 3111 is extended from the outer edge to the center of the outlet buffer cavity 311. Each of the flow-guiding structure 3221 and the flow-guiding structure 3111 is a slant surface, a curved surface or a combination of a slant surface and a curved surface. In this embodiment, the flow-guiding structures 3221 and 3111 are slant surfaces (as shown in FIG. 11A). The flow-guiding structures 3221 and 3111 are not restricted to the slant surfaces.

FIG. 11A is a schematic cross-sectional view of a fluid transportation device according to a third preferred embodiment of the present invention is illustrated. FIG. 11B is a partially schematic enlarged view of the portion C of the fluid transportation device shown in FIG. 11A. The fluid transportation device 30 principally comprises a valve seat 31, a valve cap 32, a valve membrane 23, an actuating module 24 and a cover plate 25. The operations and purposes of the valve seat 31, the valve cap 32, the valve membrane 23, the actuating module 24 and the cover plate 25 are similar to those illustrated above, and are not redundantly described herein.

In this embodiment, the flow-guiding structures 3221 and 3111 are formed in the backside of the inlet buffer cavity 322 of the valve cap 32 and the outlet buffer cavity 311 of the valve seat 31. The flow-guiding structure 3221 is extended from the outer edge to the center of the inlet buffer cavity 322 and the flow-guiding structure 3111 is extended from the outer edge to the center of the outlet buffer cavity 311. Likewise, a flow-guiding structure 3211 is formed at the inner edge of the pressure cavity 321 of the valve cap 32. When the fluid transportation device 30 is operated, the fluid flows into the inlet buffer cavity 322 through the inlet channel 312 and the valve membrane 23. Due to the flow-guiding structure 3221, no air bubble will be remained and accumulated at the corners. In other words, when the actuating module 24 is driven to be subject to deformation, the fluid is transported into the pressure cavity 321 through the inlet valve channel 323 of the valve cap 32. Likewise, due to the flow-guiding structure 3211, no air bubble will be remained and accumulated at the corners when the fluid is transported into the pressure cavity 321. When the actuating module 24 is driven to be subject to deformation again, the fluid is exhausted from the pressure cavity 321 to the outlet buffer cavity 311 through the outlet valve channel 324 of the valve cap 32 and the valve membrane 23. Likewise, due to the flow-guiding structure 3111, no air bubble will be remained and accumulated at the corners when the fluid is transported into the outlet buffer cavity 311. The fluid contained in the outlet buffer cavity 311 is then transported to the outlet channel 313.

In this embodiment, the flow-guiding structure 3221 of the pressure cavity 321 may be designed as an externally raised slant surface. For smoothly transporting the fluids, the inlet valve channel 323 and the outlet valve channel 324 may have arc surfaces for facilitating guiding the fluids into or out of the pressure cavity 321.

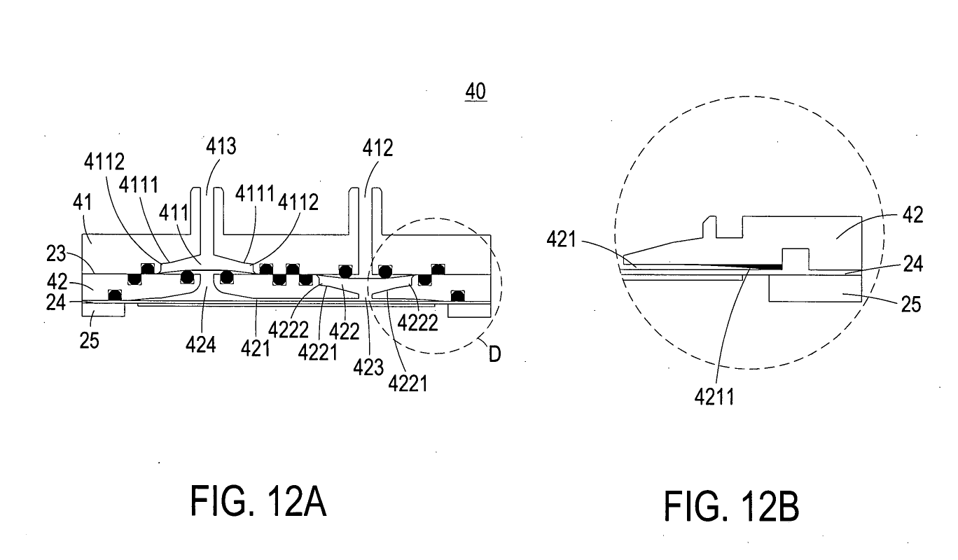

FIG. 12A is a schematic cross-sectional view of a fluid transportation device according to a fourth preferred embodiment of the present invention is illustrated. FIG. 12B is a partially schematic enlarged view of the portion D of the fluid transportation device shown in FIG. 12A. The fluid transportation device 40 principally comprises a valve seat 41, a valve cap 42, a valve membrane 23, an actuating module 24 and a cover plate 25. The operations and purposes of the valve seat 41, the valve cap 42, the valve membrane 23, the actuating module 24 and the cover plate 25 are similar to those illustrated above, and are not redundantly described herein.

For filling the resident region in the pressure cavity 421 of the valve cap 42, a flow-guiding structure 4211 is formed at the inner edge of the pressure cavity 421 of the valve cap 42 for preventing accumulation of air bubbles when a flow passes through the pressure cavity 421. As shown in FIG. 12B, the flow-guiding structure 4211 has an internally concave profile.

Please refer to FIG. 12A again. For guiding the fluids in the inlet buffer cavity 422 and the right-angle resident region 4222 of the outlet buffer cavity 411 and carrying away the air bubbles, the flow-guiding structures 4221 and 4111 are formed in the backside of the inlet buffer cavity 422 of the valve cap 42 and the outlet buffer cavity 411 of the valve seat 41. The flow-guiding structure 4221 is extended from the outer edge to the center of the inlet buffer cavity 422 and the flow-guiding structure 4111 is extended from the outer edge to the center of the outlet buffer cavity 411. In other words, the inlet buffer cavity 422 and the outlet buffer cavity 411 are funnel-shaped, so that the accumulation of air bubbles and the dead spaces of fluid transportation resulting from the right angles of the inlet buffer cavity and the outlet buffer cavity will be overcome.

In this embodiment, the flow-guiding structures 4221 and 4111 are formed in the backside of the inlet buffer cavity 422 of the valve cap 42 and the outlet buffer cavity 411 of the valve seat 41. The flow-guiding structure 4221 is extended from the outer edge to the center of the inlet buffer cavity 422 and the flow-guiding structure 4111 is extended from the outer edge to the center of the outlet buffer cavity 411. Likewise, a flow-guiding structure 4211 is formed at the inner edge of the pressure cavity 421 of the valve cap 42. When the fluid transportation device 40 is operated, the fluid flows into the inlet buffer cavity 422 through the inlet channel 412 and the valve membrane 23. Due to the flow-guiding structure 4221, no air bubble will be remained and accumulated at the corners. In other words, when the actuating module 24 is driven to be subject to deformation, the fluid is transported into the pressure cavity 421 through the inlet valve channel 423 of the valve cap 42. Likewise, due to the flow-guiding structure 4211, no air bubble will be remained and accumulated at the corners when the fluid is transported into the pressure cavity 421. When the actuating module 24 is driven to be subject to deformation again, the fluid is exhausted from the pressure cavity 421 to the outlet buffer cavity 411 through the outlet valve channel 424 of the valve cap 42 and the valve membrane 23. Likewise, due to the flow-guiding structure 4111, no air bubble will be remained and accumulated at the right-angle resident regions 4112 when the fluid is transported into the outlet buffer cavity 411. The fluid contained in the outlet buffer cavity 411 is then transported to the outlet channel 413.

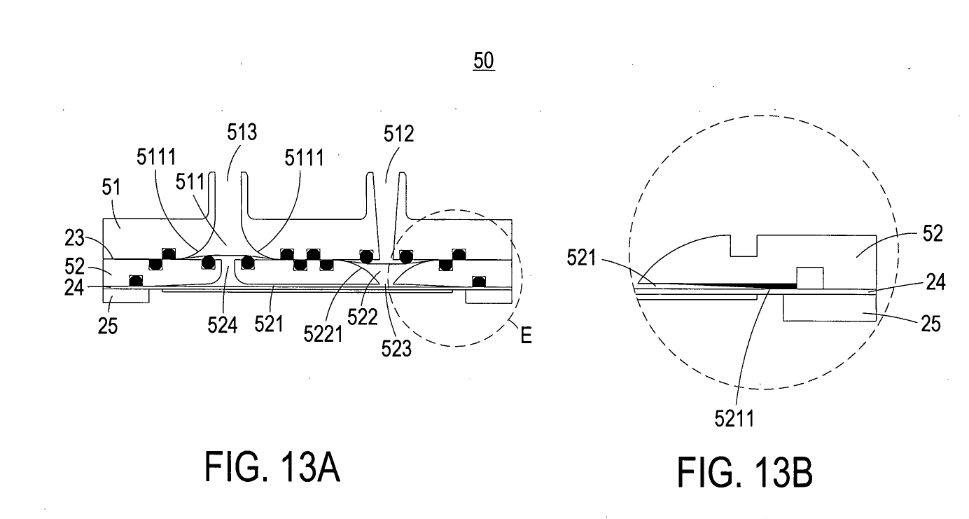

FIG. 13A is a schematic cross-sectional view of a fluid transportation device according to a fifth preferred embodiment of the present invention is illustrated. FIG. 13B is a partially schematic enlarged view of the portion E of the fluid transportation device shown in FIG. 13A. The fluid transportation device 50 principally comprises a valve seat 51, a valve cap 52, a valve membrane 23, an actuating module 24 and a cover plate 25. The operations and purposes of the valve seat 51, the valve cap 52, the valve membrane 23, the actuating module 24 and the cover plate 25 are similar to those illustrated above, and are not redundantly described herein.

For filling the resident region in the pressure cavity 521 of the valve cap 52, a flow-guiding structure 5211 is formed at the inner edge of the pressure cavity 521 of the valve cap 52 for preventing accumulation of air bubbles when a flow passes through the pressure cavity 521. As shown in FIG. 13B, the flow-guiding structure 5211 has a slant surface profile.

Please refer to FIG. 13A again. For guiding the fluids in the inlet buffer cavity 522 and the outlet buffer cavity 511 and carrying away the air bubbles according to the concept of filling the resident region of the third preferred embodiment and the concept of guiding fluids of the fourth preferred embodiment, the flow-guiding structures 5221 and 5111 are formed in the backside of the inlet buffer cavity 522 of the valve cap 52 and the outlet buffer cavity 511 of the valve seat 51. The flow-guiding structure 5221 is extended from the outer edge to the center of the inlet buffer cavity 522 and the flow-guiding structure 5111 is extended from the outer edge to the center of the outlet buffer cavity 511. In other words, the flow-guiding structures 5221 and 5111 have arc-shaped surface profiles, so that no air bubble will be remained and accumulated at the corners. The arc-shaped surface profiles of the flow-guiding structures 5221 and 5111 can facilitate guiding the fluids and carrying away the air bubbles.

In this embodiment, the flow-guiding structures 5221 and 5111 having arc-shaped surface profiles are formed in the backside of the inlet buffer cavity 522 of the valve cap 52 and the outlet buffer cavity 511 of the valve seat 51. In addition, the flow-guiding structure 5211 is formed at the inner edge of the pressure cavity 521 of the valve cap 52. When the fluid transportation device 50 is operated, the fluid flows into the inlet buffer cavity 522 through the inlet channel 512 and the valve membrane 23. Due to the flow-guiding structure 5221, no air bubble will be remained and accumulated at the corners. In other words, when the actuating module 24 is driven to be subject to deformation, the fluid is transported into the pressure cavity 521 through the inlet valve channel 523 of the valve cap 52. Likewise, due to the flow-guiding structure 5211, no air bubble will be remained and accumulated at the corners when the fluid is transported into the pressure cavity 521. When the actuating module 24 is driven to be subject to deformation again, the fluid is exhausted from the pressure cavity 521 to the outlet buffer cavity 511 through the outlet valve channel 524 of the valve cap 52 and the valve membrane 23. Likewise, due to the flow-guiding structure 5111, the air bubbles contained in the outlet buffer cavity 511 is carried away when the fluid is transported into the outlet buffer cavity 511. Moreover, the diameter of the outlet channel 513 may be increased in order to reduce the flow resistance of the outlet channel 513 and facilitate exhausting the fluid through the outlet channel 513.

The fluid transportation device of the present invention is applicable to a micro pump. The valve seat, the valve membrane, the valve cap and the actuating module are sequentially stacked from bottom to top, thereby assembling the fluid transportation device. The actuating module is activated to change the volume of the pressure cavity so as to open or close the inlet/outlet valve structures of the valve membrane. The sealing rings and the recess structures in the valve seat or the valve cap are cooperated to facilitate fluid transportation. The fluid transportation device of the present invention can transport gases or liquids at excellent flow rate and output pressure. The fluid can be pumped in the initial state and with a high precision controllability. Since the fluid transportation device is able to transport gases, the bubble generated during the fluid transportation may be removed so as to achieve efficient transportation.

Moreover, several buffer cavities of the fluid transportation device have flow-guiding structures extended from the outer edges to the centers thereof. In addition, an additional flow-guiding structure is formed at the inner edge of the pressure cavity for preventing accumulation of air bubbles and guiding the fluids. Due to these flow-guiding structures, no air bubble or residual fluid will be remained and accumulated at the corners.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A fluid transportation device for transporting a fluid, said fluid transportation device comprising:
a valve seat having an inlet channel and an outlet channel;
a valve cap disposed on said valve seat;
a valve membrane arranged between said valve seat and said valve cap;
multiple buffer chambers including a first buffer chamber between said valve membrane and said valve cap and a second buffer chamber between said valve membrane and said valve seat, wherein each of said first buffer chamber and said second buffer chamber has a flow-guiding structure extended from an outer edge to a center thereof; and
an actuating module having a periphery fixed on said valve cap, wherein a pressure cavity is defined between said actuating module and said valve cap, and another flow-guiding structure is formed at an inner edge of said pressure cavity.

2. The fluid transportation device according to claim 1 wherein said fluid includes a gas or a liquid.

3. The fluid transportation device according to claim 1 wherein said flow-guiding structures of said buffer chambers are slant surfaces.

4. The fluid transportation device according to claim 1 wherein said flow-guiding structures of said buffer chambers are curved surfaces.

5. The fluid transportation device according to claim 1 wherein each of said flow-guiding structures of said buffer chambers is a combination of a slant surface and a curved surface.

6. The fluid transportation device according to claim 1 wherein said flow-guiding structure of said pressure cavity is a slant surface.

7. The fluid transportation device according to claim 1 wherein said flow-guiding structure of said pressure cavity is a curved surface.

8. The fluid transportation device according to claim 1 wherein the diameter of said outlet channel is greater than that of said inlet channel.
